(19) United States
(12) Patent Application Publication
(10) Pub. No.: US 2008/0159912 A1
(43) Pub. Date: Jul. 3, 2008

(54) Optochemical Sensor Membrane and Method for Producing the Same

(76) Inventors: Nathalie Dantan, Berlin (DE); Harald Kohlhoff, Berlin (DE); Marek Hohse, Berlin (DE)

Correspondence Address: THELEN REID BROWN RAYSMAN & STEINER LLP, P.O. BOX 640640, SAN JOSE, CA, 95164-0640, US

(21) Appl. No.: 11/908,497

(22) PCT Filed: Mar. 15, 2006
(86) PCT No.: PCT/EP2006/060736

§ 371 Date: Mar. 26, 2008

(30) Foreign Application Priority Data
Mar. 16, 2005 (DE) 10 2005 013 198.0

(51) Int. Cl. G01N 21/77; B29C 43/02

(52) U.S. Cl. 422/56; 264/78

(57) ABSTRACT

The invention relates to an optochemical sensor membrane based on color indicators and sorbents for use in solid-phase extraction and to a method for producing the same. The optochemical sensor membrane consists of a sintered membrane from a thermally deformable powdery sorbent material and a color indicator bound to the sorbent material and produced by homogeneously mixing sorbent material particles with a color indicator solution, drying the separated and washed particles, processing the dried solid particles to give a homogeneous powder, compacting the resulting powder in a mold at 25 to 35 bar and heating the sorbent material to sintering temperature, cooling it off and removing it from the mold. The membranes so produced have a homogeneous structure and excellent chemical and mechanical stability.

The invention relates to an optochemical sensor membrane based on dye indicators and sorbents for solid-phase extraction.

Opto-chemical sensors, also called optodes, are known to be used for in-situ measuring, without externally applied wet-chemical process needing to be employed. The analyte-sensitive membranes contained therein are used for example to determine pH values of liquid media.

Manufacturing analyte-sensitive membranes is a relevant step in developing optical chemical sensors. Basically, such sensor membranes are prepared by a dye indicator, which reversibly alters its optical properties depending on the concentration of the analytes to be measured, being immobilised on a suitable carrier material. Examples of classic immobilising methods are anchoring, covalent bonding or adsorption of dye molecules.

As described in DE 19904938 A1, the dye molecules are embedded in a porous polymer material in principle during anchoring. Though this process is relatively simple and reliable, its disadvantage is that the dye molecules are often washed out into the medium to be examined.

Covalent bonding is based on the dye molecules being covalently coupled to molecules of the carrier material. Due to the high chemical stability of this type of bonding washing out of dyes during the measuring procedure is excluded. This process however is relatively complicated and time-intensive. It is also a disadvantage that both dye and carrier molecules must have the functional group necessary for covalent coupling. This is what restricts the use of this methodology in practice.

With the sorption process dye molecules are bound by physical and/or chemical interactions (e.g. hydrogen bridge building, van der Waals forces, polar and ionic interactions) to a polymer material. It is advantageous here that countless sorbents can be used for solid-phase extraction of varying kind (e.g. adsorber resin, ion exchanger), available commercially as spheres. As a rule dye enriching is distinguished by simplicity and reproducibility. In the literature, as explained in U.S. Pat. No. 4,907,0367, with the production of optodes there are reports on the use of dyed sorbent spheres instead of membranes as analyte-sensitive constituent in combination with optical lines. Many authors however describe also the making of ready-to-use analyte-sensitive membranes, whereby the spheres are embedded in a polymer solution following dye enrichment, which is drawn as a thin layer (Fresenius Journal of Analytical Chemistry, Vol 364, 605, 1999. It is a disadvantage that the membranes resulting from this process due to the relatively uneven sphere distribution and partial dye washing out in the polymer mass exhibit a barely homogeneous structure, which may lead to unreliable measuring results. To eliminate this problem it was put forward in SPIE, Vol. 3538, 319, 1998 to first pulverise the dyed spheres and then to incorporate them in the polymer solution, although this is associated with only a moderate improvement in homogeneity.

The technical problem is to produce analyte-sensitive membranes, exhibiting a homogeneous structure and the chemical and mechanical stability necessary for use, as constituent of an optical chemical sensor, with which the concentration of analytes can be determined. This type of sensor should either be able to be added in as often as possible to the environment to be analysed for the measuring procedure or be permanently integrated.

According to the invention the optochemical sensor membrane based on dye indicators and sorbents for solid-phase extraction comprises a sinter membrane made of a thermally deformable pulverulent sorbent material and a dye indicator bound to the sorbent material, made by homogeneous mixing of sorbent material particles with a dye indicator solution, drying the separated and washed particles, processing the dried particles to a powder with a particle size of 5 to 15 μm, pressing the resulting powder in a moulding tool with 25 to 35 bar and heating to sintering temperature of the sorbent material, cooling, mould release and if required hydrophilising the resulting optochemical membrane. The dye indicator is bound sorptively and in fully homogeneous distribution to the sorbent material.

The thermally deformable sorbent material is preferably a hydrophilic sorbent for solid-phase extraction, suitable for dye immobilising via physical and/or chemical interactions. Examples of such sorbents are non-functionalised and functionalised cross-linked polystyrene-divinylbenzene, such as Amberlite® XAD4, XAD16, 200 or Dowex® 50W.

The sorbent is here in the form of solid particles with a particle size in the range of 100 to 1200 μm and is processed after dye sorption to a powder with a particle size of 5 to 15 μm.

The dye indicator preferably reversibly alters its optical properties depending on the concentration of the analytes to be measured.

Commercially available dyes can be used as dye indicator with respect to the analytes to be measured in the preferred concentration ranges. For example, pH indicators such as alizarin, bromocresol purple, bromocresol green, bromophenol blue, chlorphenol red, neutral red, phenolphthalein, phenol red or thymol blue depending on the preferred area of application can be used to determine pH values.

The requisite for using dye indicator and sorbent material is that these are also chemically stable in their interaction in the medium to be examined. The requisite is also that the dye and the interactions for sorption at sinter temperature of the sorbent material are stable.

The dye indicator is dissolved in a suitable solution medium. Next the sorbent material particles of the resulting dye solution are added and mixed until all sorbent particles have been evenly coloured with the dye. In the process rotary speeds of the stirrer of 1000 to 2000 rpm and a period of 12 to 48 hours are preferred. Excellent sorption of the dye molecules on the particles of the sorbent material is achieved by homogeneous mixing and if required subsequent comminution of the solid particles.

“Sorption” is understood to mean not covalent binding, rather binding via hydrogen bridges, van der Waals forces, polar and ionic interactions or the sum of several of these bindings.

The solid particles found in the dye solution are filtered out and repeatedly rinsed to remove the unbound indicator, preferably with distilled water. They are then dried. Drying takes place at a maximal temperature of 40° C. Next, the dried solid particles are processed into a homogeneous powder with a particle size of 5 to 15 μm.

A defined quantity of the powder is placed in a pressing tool, compressed at a pressure of 25-35 bar to produce a compact layer, and sintered at the sinter temperature of the sorbent material. The period required for this is a few minutes. The sinter temperature depends on the sorbent material and can be set by the specialist himself. In general, the pressing tool is heated to between approximately 200 and 600° C. for this purpose.

Depending on the sorbent material used the optochemical sensor membrane obtained after mould release is brought into contact with a suitable solution medium (e.g. ethanol) to hydrophilise it and thus enable later usage.

The inventive sensor membrane is distinguished by the following advantages:
increased homogeneity and chemical stability
high reproducibility of chemical and optical properties
any variation of geometric measurements
possibility of simple design of a sensor by the mechanically stable properties of the membrane
reliable determining of the concentration of countless analytes in any measuring range by targeted selection of inter-combinable dye indicators and carrier materials.

A preferred optochemical sensor membrane based on dye indicators and sorbents for solid-phase extraction is characterised by a sinter membrane made of thermally deformable, cross-linked polystyrene-divinylbenzene Amberlite® XAD4 and the dye indicator thymol blue adsorbed on this adsorber material, made by homogeneous mixing of Amberlite® XAD4 particles with an alcohol solution of thymol blue, drying of the separated particles washed repeatedly with water, processing of the dried solid particles to a powder with a particle size of 5 to 15 μm, pressing of the resulting powder in a moulding tool with 28 to 30 bar and heating of the moulding tool to 400-450° C., cooling, mould release and hydrophilising of the resulting optochemical membrane with alcohol.

A suitable alcohol for hydrophilising is a monovalent or multivalent alcohol, such as for example ethanol, propanol, isopropanol, butanol, propylene glycol, glycerin or a mixture of alcohols, preferably ethanol.

Strongly alkaline media are preferably suitable as media to be measured for the optochemical sensor membrane preferred according to the invention and based on Amberlite® XAD and thymol blue, such as for example concrete construction, in which such sensor membranes are integrated prior to hardening of the concrete and later pH value modification can easily be read.

Another object of the invention is the process for making an optochemical sensor membrane based on dye indicators and sorbents for solid-phase extraction, based on producing a sinter membrane made of a thermally deformable pulverulent sorbent material and a dye indicator bound to the sorbent material, through homogeneous mixing of sorbent material particles with a dye indicator solution, drying the separated and washed particles, processing the dried solid particles to a powder with a particle size of 5 to 15 μm, pressing the resulting powder in a moulding tool with 25 to 35 bar and heating to sintering temperature of the sorbent material for a period of a few minutes, cooling and mould release. This can be hydrophilised if required.

The invention will now be explained in greater detail through examples.

### EXAMPLE 1

Starting substances are the pH-dye indicator thymol blue and the adsorber material Amberlite® XAD4 (cross-linked polystyrene-divinylbenzene) with a particle size of 200 to 800 μm. The pKs value of this indicator can be shifted to higher values by targeted selection of the sorbent, necessary for the above application to be able to cover the preferred pH range of 9-12.

All chemicals used are commercially available in the required chemical purity. To pre-pare a pulverulent and adsorber material enriched with indicator dye molecules 50 mg of the indicator thymol blue are dissolved in 20 ml ethanol and 5 g of Amberlite® XAD4 particles are added thereto. The resulting dye solution is agitated with a magnetic stirrer with ca. 1000 to 2000 rpm until all adsorber material particles have been homogeneously coloured orange. A period of 5 days for this is preferred.

The adsorber particles are filtered and rinsed several times with distilled water to remove the unbound thymol blue. Both eluate and particles are dyed blue during rinsing. Rinsing is continued until the particles become orange again. The particles are then processed into a homogeneous powder with a particle size of 5 to 15 μm. Finally the resulting powder is dried at room temperature.

7.5 mg of the dried powder are introduced to a pressing tool made of stainless steel, compressed with a pressure of 28-30 bar and sintered. The sinter procedure requires a two-minute phase of pressure and temperature effect at 400-450° C. on the pressing tool.

Under these conditions homogeneous and cylindrical membranes with a diameter of 5 mm and a thickness of 0.2 mm are made.

To maintain the hydrophility of the adsorber material it must be stored in the moist state according to the manufacturer's instructions. This material—if dried out—can in principle be re-hydrophilised with a solution containing alcohol. Accordingly, the membranes made of the dried powder show after brief effect of ethanol a reversible change of colour from orange to blue in the pH range of 9-12.

1. An optochemical sensor membrane based on dye indicators and sorbents for solid-phase extraction, characterised by a sinter membrane made of a thermally deformable pulverulent sorbent material and a dye indicator bound to the sorbent material sorptively and in fully homogeneous distribution, made by homogeneous mixing of sorbent material particles with a dye indicator solution, drying the separated and washed particles, processing the dried solid particles to a homogeneous powder with a particle size of 5 to 15 μm, pressing of the resulting powder in a moulding tool with 25 to 35 bar and heating to sintering temperature of the sorbent material for a period of a few minutes, cooling and mould release of the resulting optochemical membrane.

2. The optochemical sensor membrane as claimed in claim 1, characterised in that dye indicator is such that it reversibly alters its optical properties depending on the concentration of the analytes to be measured.

3. The optochemical sensor membrane as claimed in claim 2, characterised in that the dye indicator is a pH indicator.

4. The optochemical sensor membrane as claimed in claim 1, characterised in that due to physical and/or chemical interactions the sorbent material is suitable for dye immobilising and is hydrophilic.

5. The optochemical sensor membrane as claimed in claim 1, characterised in that it is a cross-linked polystyrene-divinylbenzene.

6. The optochemical sensor membrane as claimed in claim 1, characterised in that the sorbent particles are processed to a homogeneous powder with a particle size of 5 to 15 μm after dye sorption.

7. The optochemical sensor membrane as claimed in claim 1, characterised in that pressing of the powder in a moulding tool with 28 to 30 bar is carried out.

8. The optochemical sensor membrane as claimed in claim 1, characterised in that heating to sinter temperature of the sorbent material is carried out.

9. The optochemical sensor membrane as claimed in claim 1, characterised in that the sintered sorbent material is in hydrophilised form.

10. The optochemical sensor membrane as claimed in claim 1, characterised in that it is a sinter body made of thermally deformable sorbent material particles made of cross-linked polystyrene-divinylbenzene Amberlite® XAD4 with a particle size of 200 to 800 μm and the dye indicator thymol blue adsorbed on this adsorber material, made by homogeneous mixing of Amberlite® XAD4 particles with an alcoholic solution of thymol blue, whereby mixing with 1000 to 2000 rpm for 4 to 5 days is carried out, drying of the separated adsorber particles washed several times with water, processing of the dried solid particles to a powder with a particle size of 5 to 15 μm, pressing the resulting powder in a moulding tool with 28 to 30 bar and heating the moulding tool to 400-450° C., cooling, mould release and hydrophilising of the resulting optochemical membrane with alcohol.

11. A process for producing an optochemical sensor membrane based on dye indicators and sorbents for solid-phase extraction, characterised by homogeneous mixing of thermally deformable sorbent material particles with a dye indicator solution, drying the separated and washed particles, processing the dried solid particles to a powder with a particle size of 5 to 15 μm, pressing of the resulting powder in a moulding tool with 25 to 35 bar and heating to sintering temperature of the sorbent material for a period of a few minutes, cooling and mould release.

12. The process as claimed in claim 11, characterised in that the sensor membrane is hydrophilised with a suitable solution medium depending on the sorbent material.
